(19) United States
(12) Patent Application Publication
(10) Pub. No.: US 2008/0128450 A1
(43) Pub. Date: Jun. 5, 2008

(54) Patient specific medication dispenser

(75) Inventors: Terri O'Gorman, New York, NY (US); Lynda B. Edelson, New York, NY (US)

Correspondence Address: PFIZER INC;Steve T. Zelson, 150 EAST 42ND STREET, 5TH FLOOR - STOP 49, NEW YORK, NY, 10017-5612, US

(73) Assignee: Pfizer Inc.

(21) Appl. No.: 11/018,113

(22) Filed: Dec. 20, 2004

Related U.S. Application Data
(60) Provisional application No. 60/532,806, filed on Dec. 24, 2003.

(51) Int. Cl. B65H 3/58; G07F 11/66

(52) U.S. Cl. 221/26; 221/25

(57) ABSTRACT

A patient specific medication kit includes a holder and a plurality of packages, with each package containing at least one medication element, such as a pill, capsule or tablet. Each package is slidably, removably disposed in the holder in a prescribed sequence. Each package or medication element contains indicia signifying the medication element dosage. The holder has indicia signifying the prescribed disposition of the packages in the holder, which disposition is in accordance with a prescribed medication dosage regimen sequence

This applications claims priority under 35 USC 119 of U.S. Provisional Application 60/532,806, filed Dec. 24, 2003. The entire content of the prior application, U.S. Provisional Application 60/532,806, is incorporated herein by reference.

### FIELD OF THE INVENTION

This invention relates to medication dispensers. Specifically, this invention relates to medication dispensers to provide medication specific to a particular patient or subject in a prescribed dosage regimen sequence.

### BACKGROUND OF THE INVENTION

It is known in the marketing or testing of a new pharmaceutical product to provide a specific predetermined number of the pharmaceutical product sample elements, e.g. pills, in a specific predetermined dosage onto a card in a blister pack. The card identifies the product and provides relevant information for the physician and patient. Such packaging are disclosed in U.S. Pat. No. 6,635,225, granted Apr. 23, 2002 to Lapsker; U.S. Pat. No. 5,961,51, granted Oct. 5, 1999 to Tung et al.; U.S. Pat. No. 5,908,208, granted Jun. 1, 1999 to Lapsker; and U.S. Pat. No. 5,799,981, granted Sep. 1, 1998 to Tung et al. Tung et al. and Lapsker disclose a construction wherein a predetermined number of product sample pills in a predetermined dosage are secured onto a card in a blister pack.

Pharmaceutical products are generally produced in bulk medication elements (e.g. pills) in predetermined prescribed dosages. Pills are generally manufactured and supplied in bulk amounts. Additionally, pharmaceutical manufacturers often produce trial samples containing specific dosages, usually in blister packs for distribution to the physician for dispensing to patients, in order to promote the particular product. In some instances, the physician may dispense the sample blister packs to a patient with instructions as to the dosage regimen. The physician may, however, be reluctant to dispense the blister packs to certain patients, namely those having limited pharmacological acumen, limited comprehension or advanced age, inasmuch as the prescribed dosage regimen sequence using the sample packages may not be properly adhered to by patients having such impairments. Moreover, the particular dosage strengths and number of pills provided in the sample blister packs may suggest to the patient a dosage regimen that is different from the dosage regimen prescribed by the physician. The patient may consequently be confused, and may inadvertently depart from the regimen prescribed by the physician.

In light of the foregoing disadvantages, physicians desire a means for using pharmaceutical product sample packages in a manner to insure that the patient administers the pills according to the physician prescribed dosage regimen sequence. Pharmaceutical manufacturers desire that physicians be provided with means for readily promoting and dispensing their product samples in specific desired dosage regimens.

Accordingly, it is a principal object of the present invention to provide a patient-specific medication dispenser or kit and assembly method therefore that resolves the foregoing pharmaceutical manufacturers' and physicians' needs.

It is a further object of the present invention to provide a medication dispenser and method as aforesaid, which is readily assembled by a medication provider, such as a physician, for use by a specific patient or subject.

It is a further object of the present invention to provide a medication dispenser and method as aforesaid wherein diverse pharmaceutical product sample packages may be used with the dispenser.

It is still a further object of the present invention to provide a medication dispenser and method as aforesaid that readily accommodates diverse dosage regimens.

It is still a further object of the present invention to provide a medication dispenser and method as aforesaid which is particularly useful as a starter kit.

It is still a further object of the present invention to provide a medication organizer and method which is safe and practicable in design and use, and may be used by a broad range of patients or subjects, particularly including those patients or subjects of limited pharmacological acumen or having some minimal level of physical or intellectual impairment.

It is still of further object of the present invention to provide a medication dispenser and method as aforesaid which services a broad range of patients as afore-discussed, and is also childproof so as to prevent unwanted removal and ingestion of the medication by a child.

The present invention achieves the aforementioned objects, and provides other advantages and improvements, as will become apparent from the following description.

### SUMMARY OF THE INVENTION

A patient specific medication dispenser kit includes a holder and a plurality of pharmaceutical product packages, wherein each package contains at least one medication element of a specific pharmaceutical product. The packages are separately removably inserted in the holder. The package or medication element contains indicia identifying the specific pharmaceutical and signifying the medication element (e.g. pill, capsule, tablet) dosage. The holder has indicia signifying the dosage regimen and the daily removal sequence of the packages. The holder is constructed of foldable conjoined panels. When unfolded open, the physician or medication provider inserts the packages in the holder. When folded closed, the holder is provided with childproof means. The blister packs are also provided with childproof means.

The packages may be pharmaceutical product sample blister packs or packages. These product blister packs may contain different dosages of the medication element (e.g., a pill or pills, as the case may be). The blister packs may be color coded to readily identify the respective dosages.

In another aspect, the invention is a medication provider's method of assembling pharmaceutical product sample packages in a holder to provide a patient-specific medication dispenser. By such method, a broad range of patients may be given different dosage sequences. The medication dispenser is particularly useful as a starter kit.

In another aspect, the present invention is a medication provider's method for providing a medication kit to a patient or subject, which method includes;

providing pluralities of packages containing respective medication elements, which pluralities of packages include a first plurality of packages containing respective medication elements comprising a first dosage and a second plurality of packages containing respective medication elements comprising a second dosage strength;

providing a holder comprising means (e.g. slots) for removably receiving packages of (a) in a daily sequence;

assembling at least one package of said first plurality of (a) and at least one package of said second plurality of (a) in the holder of (b) in a daily medication dosage regimen sequence to form an assembled medication kit having a specific medication dosage regimen specific to the patient or subject, and

(d) providing the assembled medication kit to the patient or subject.

### BRIEF DESCRIPTION OF THE DRAWINGS

FIG. 1 is a plan view of one outside panel of the medication dispenser holder in the folded closed position;

FIG. 2 is a plan view of another outside panel of the medication dispenser holder as shown in FIG. 1;

FIG. 3 is assembly view of the inside of the medication dispenser holder of FIG. 1 shown in the unfolded open position, with juxtaposed exemplary blister packs for insertion in the holder;

FIG. 4 is the medication dispenser as show in FIG. 3 with the medication element blister packs assembled in the holder;

FIG. 5 is a plan view of the outside panels of the unfolded open medication dispenser holder;

FIG. 6 is a fragmentary view of the inside of the medication dispenser holder as shown in FIG. 5, showing the slidably removable insertion of a medication element blister pack in opposed mirror image slots formed in the holder inside panels; and

FIG. 7 is an enlarged sectional view taken along line 7-7 of FIG. 1.

### DESCRIPTION OF THE INVENTION

Referring to the FIGS., there is shown the patient-specific medication dispenser 10 of the present invention. Dispenser 10, in general, includes a cardboard or paperboard holder 11 and a plurality of blister packs 12, 13, 14, and 15 (typical) containing respective medication elements, e.g. capsules 12A, 13A, 14A and 15A.

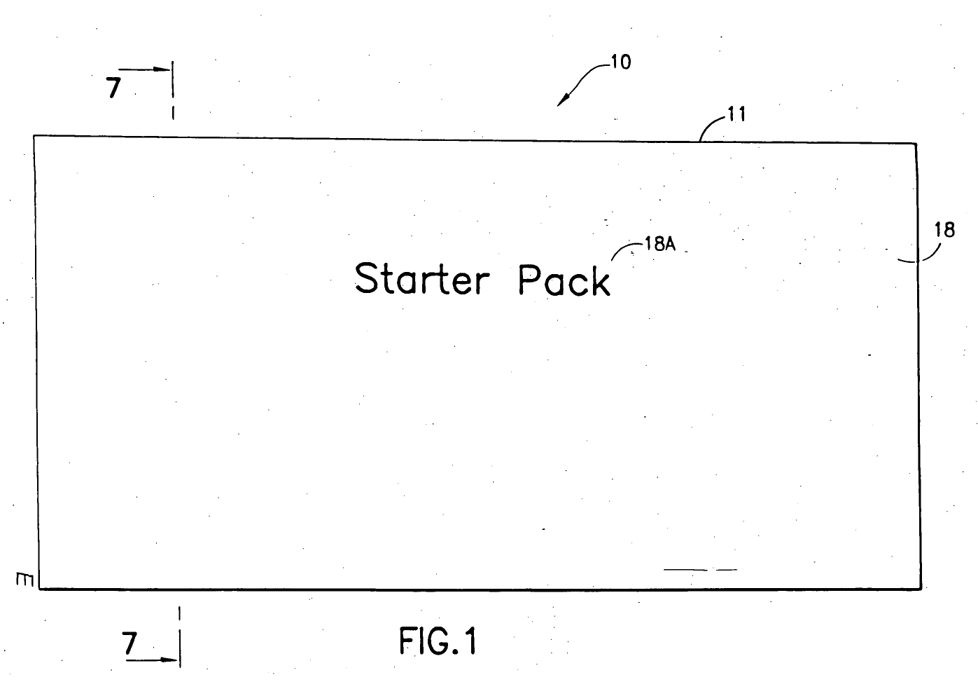

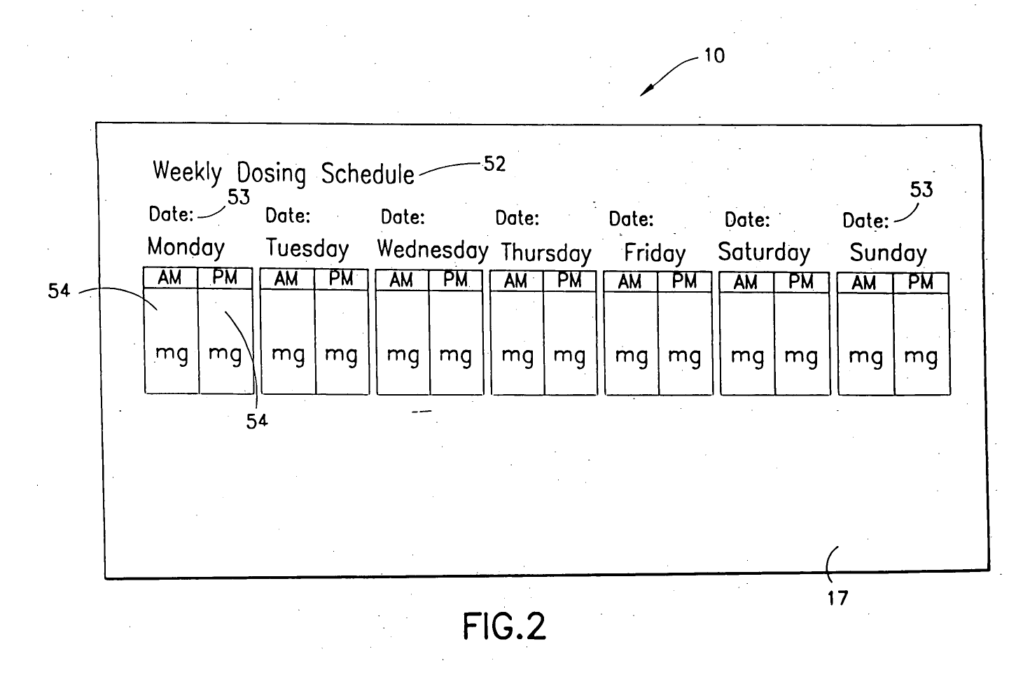

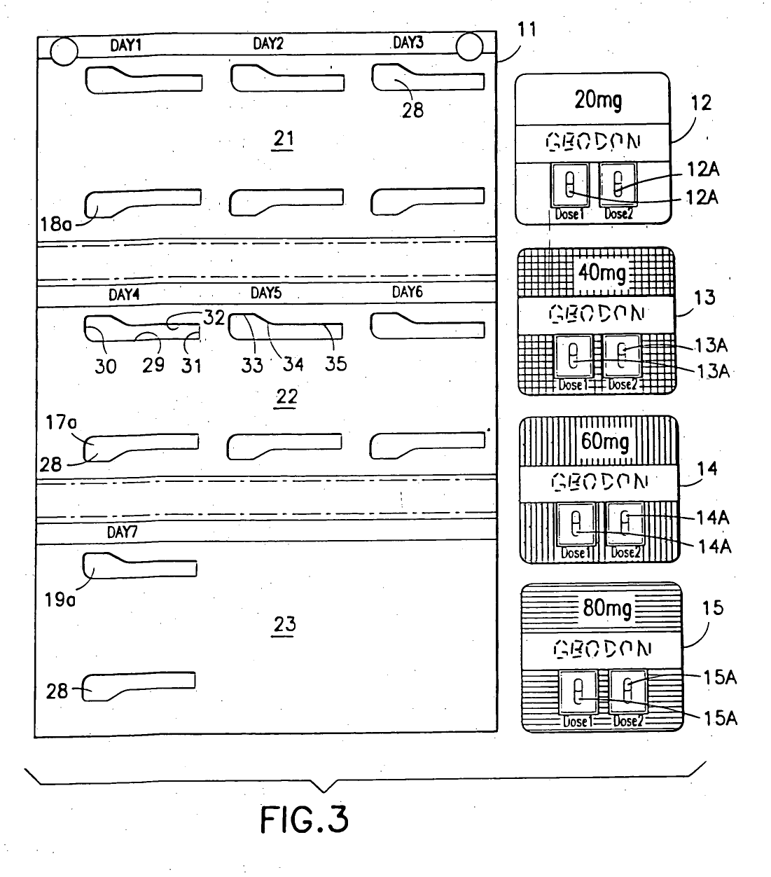

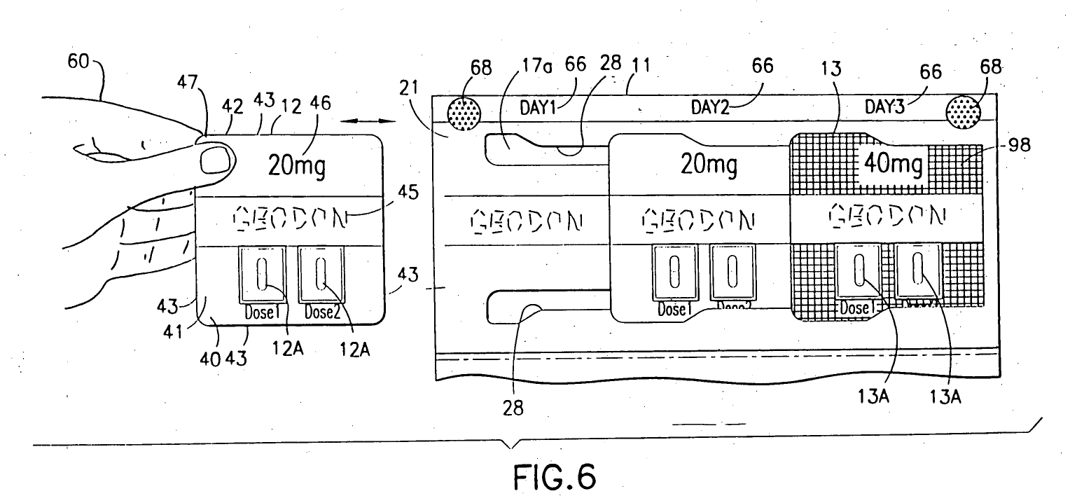

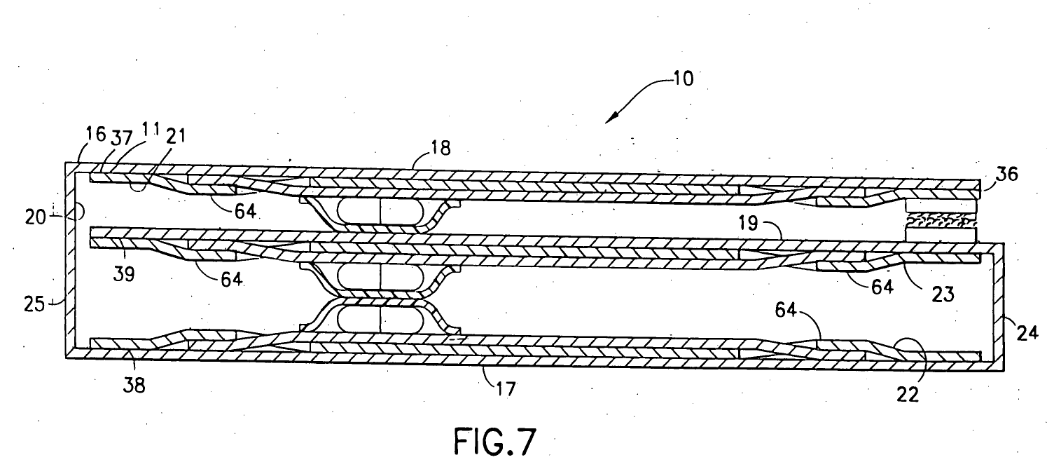

Holder 11 has an outside 16 which has 3 elongated outer panels or surfaces 17, 18 and 19, and an inside 20 which has 3 elongated inner panels or surfaces 21, 22, and 23. The holder 11 has two folds or hinges 24 and 25, which interconnect the aforesaid panels so that the panels are foldably conjoined. In this manner of construction, the holder may be folded closed, as best shown in FIGS. 1, 2 and 7, or alternatively, unfolded open, as best shown in FIGS. 3 and 6.

Panel 18 has dispenser identifying indicia 18A, which in this embodiment identifies medication dispenser 10 as a “Starter Pack”, as will be more fully discussed hereinafter.

Inside panels 21, 22 and 23 are formed with pairs of spacedly opposed mirror-image elongated slots 28 (typical). Slots 28 are formed with inner edge 29, side edges 30 and 31 and outer edge 32. Edge 32 has an outer edge 33, and contiguous angularly disposed edge 34 and edge 35. The aforesaid edges form slot 28. The surfaces 17a, 18a and 19a, of respective outer panels 17, 18 and 19 are exposed by slots 28 formed in inner panels 21, 22 and 23. The outer and inner panels are permanently adhesively affixed at their respective peripheries, e.g. 36, 37, 38 and 39, by means well known in the art. The inner panel surfaces unopened slots 28 flex with respect to the outer panel, when the blister packs are slidably inserted in slots 28. Slots 28 are so formed for removably, slidably receiving medication element blister packs 12-15, as will be more fully explained hereinafter.

Each medication element blister pack, e.g. 12 (FIG. 6), is formed with an about rectilinear cardboard backing 40, having front 41, back 42 and peripheral edge 43. Two clear plastic blister elements 44 are adhesively secured to front 41, by means well known in the art. Front 41 bears (i) medication identifying indicia 45 (e.g. trademark, trade name and/or chemical name), (ii) medication element (e.g. capsule) dosage indicia 46, and optionally, (iii) dosage color-coding 47. The other blister packs have other respective dosage indicia and optional corresponding dosage color-coding, 48, 49 and 50.

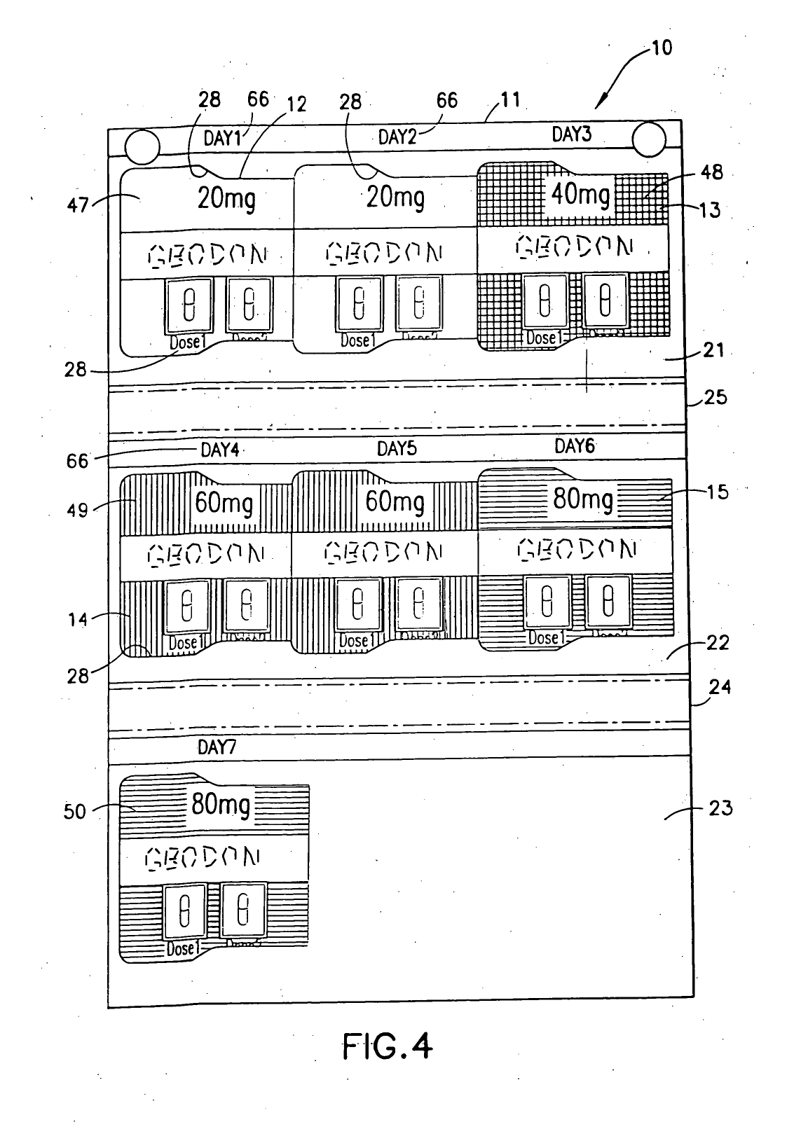

Optionally, outer panel 17 contains a weekly dosage schedule 52. Schedule 52 is used by the medication provider (e.g. physician) to prescribe and inscribe the weekly dosage. The medication provider inscribes the date at 53 (typical) and the corresponding AM and PM dosages at 54 to be administered on that date. The schedule 52, as shown, is for a twice or bi-daily (BID) dosage regimen. The inner panels bear day identifying indicia 66 (typical) juxtaposed to a respective pair of slots (FIG. 4). Other weekly dosages schedules are within the contemplation of the present invention. Schedule 52 and the blister packs may be readily configured to accommodate other dosage regimens.

In the aforesaid manner of construction, the medication provider completes the weekly dosage schedule 52. The medication provider 60 then inserts the respective blister packs into the respective slots (see FIGS. 4 and 6) in the prescribed dosage regimen sequence. As previously stated, the inner panels bear respective day indicia 66. The day indicia 66 reads sequentially left to right corresponding to the weekly dosage schedule 52. After completion of the blister pack insertion (FIG. 4), the medication provider 60 provides the assembled medication dispenser kit to the patient. The patient then readily sequentially removes the blister packs and administers the medication in accordance with the day indicia on the inner panels as well as on the weekly dosage schedule 52, if so present on the outer panel.

The afore-described construction provides the physician with a means and method for readily prescribing a starter dosage regimen comprising trial size medication element packages, in a kit wherein error as to the dosage regimen and administration is greatly diminished or effectively eliminated.

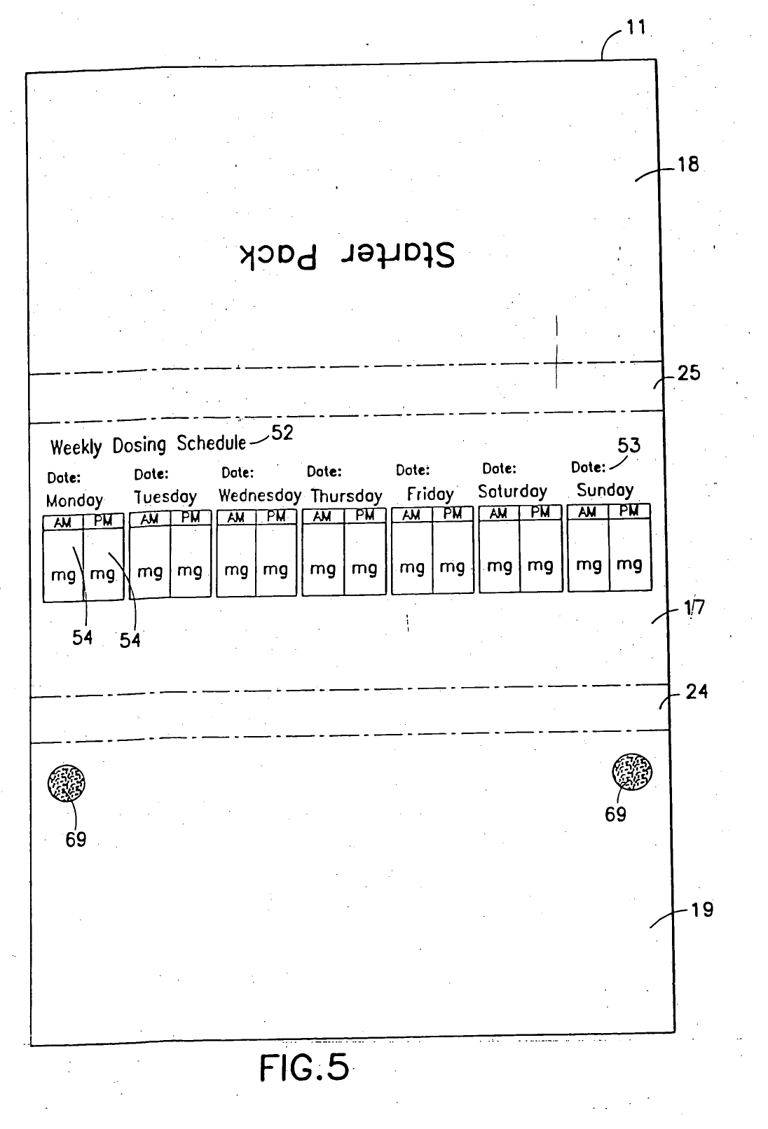

Inner panel 21 is provided with a pair of spacedly disposed Velcro elements 68 (FIG. 6). Outer panel 19 is formed with a corresponding pair of spacedly disposed Velcro elements 69 (FIG. 5). When the panels 21 and 19 are folded closed, Velcro elements 68 lockingly engage Velcro elements 69. In this manner of construction, the holder is not readily opened, so as to provide childproofing means. The blister pack per se provides childproof means, as well.

The present invention is useful for a broad range of pharmaceuticals in diverse medication elements. The present invention is particularly useful for the administration of GEODON. GEODON is a trademark of Pfizer Inc., New York, N.Y. GEODON is available in capsules. GEODON capsules are differentiated by capsule color/size. GEODON capsules are supplied for oral administration in 20 mg (blue/white), 40 mg (blue/white), 60 mg (white/white), and 80 mg (blue/white) capsules. They are supplied in bulk, as well as trial size blister packages. Patients are preliminarily assessed and periodically reexamined to determine the initial (starter) and subsequent dosage administration regimens. The present invention is particularly useful in providing a starter kit for GEODON.

The present invention is, however, not to be limited in scope by the specific examples disclosed herein. Indeed, various modifications of the invention in addition to those described herein will be apparent to one of skill in the art from the foregoing description and accompanying figures. Such modifications are intended to fall within the scope of the appended claims.

1. A medication dispenser kit comprising in combination:
a plurality of packages, each said package containing at least one medication element, wherein said package or said medication element further comprises indicia signifying the medication element dosage; and
a holder, and wherein the holder comprises means for removably holding the packages.

2. The medication dispenser kit of claim 1, wherein said holder comprises indicia signifying the daily sequence disposition of the packages in the holder.

3. The medication dispenser kit of claim 1, said plurality of packages comprises a first plurality of packages containing respective medication elements comprising a first dosage strength and a second plurality of packages containing respective medication elements comprising a second dosage strength.

4. The medication dispenser kit of claim 1, wherein said holder comprises slots, said packages being slidably, removably disposed in the slots.

5. The medication dispenser kit of claim 3, wherein at least one package of said first plurality and one package of said second plurality are removably disposed in said holder.

6. The medication dispenser kit of claim 1, said holder comprising indicia signifying the disposition of the packages in the holder.

7. The medication dispenser kit of claim 1, wherein the packages comprise blister packs.

8. The medication dispenser kit of claim 1, wherein the kit comprises childproof means for preventing a child from accessing a medication element.

9. The medication dispenser kit of claim 1, said holder comprising a plurality of foldable conjoined panels.

10. A medication provider method for providing a medication dispenser kit to a patient or subject, said method comprising:
providing pluralities of packages containing respective medication elements, which pluralities of packages comprise a first plurality of packages containing respective medication elements comprising a first dosage and a second plurality of packages containing respective medication elements comprising a second dosage strength;
providing a holder comprising means for removably receiving said packages in a daily sequence;
assembling at least one package of said first plurality of packages and at least one package of said second plurality of packages in the holder in a daily medication dosage regimen sequence to form an assembled medication kit having a specific medication dosage regimen specific to the patient or subject;

11. The method of claim 10, further comprising (d) providing the assembled medication kit to a patient or subject.

12. The method of claim 10, said holder comprising indicia for signifying the disposition of the first plurality package and the second plurality package in the holder in a prescribed medication dosage regimen sequence.

13. The medication kit of claim 10, wherein the assembled kit comprises childproof means for preventing a child from accessing a medication element.

14. The method of claim 10, said holder comprising a plurality of conjoined panels, said panels being in folded disposition.

15. The method of claim 10, wherein said packages or said medication elements comprise indicia signifying the respective medication elements dosages.

16. The method of claim 15, wherein the indicia comprises color indicia.

17. The method of claim 10, further comprising slidably inserting the packages into the means for removably receiving said packages.

18. The method of claim 17, wherein slidably inserting the packages further comprises slidably inserting the packages into slots in the holder.

19. The method of claim 10, wherein step (a) comprises providing a plurality of holders.

20. The method of claim 10, wherein the packages are blister packages with the medication elements prepackaged therein.
